(19) United States
(12) Patent Application Publication
(10) Pub. No.: US 2014/0211031 A1
(43) Pub. Date: Jul. 31, 2014

(54) AUTO PICTURE ALIGNMENT CORRECTION

(71) Applicant: MICROSOFT CORPORATION, Redmond, WA (US)

(72) Inventor: Amy Aimei Han, Portola Valley, CA (US)

(73) Assignee: MICROSOFT CORPORATION, Redmond, WA (US)

(21) Appl. No.: 13/754,719

(22) Filed: Jan. 30, 2013

(51) Int. Cl. H04N 5/225

(52) U.S. Cl. CPC H04N 5/225
USPC 348/208.99; 348/222.1

(57) ABSTRACT

A camera device is disclosed. The camera device includes a sensor to capture an image, a sensor to detect direction of gravity and a processor configured to extract a part of the image to produce a horizontally aligned image from the image using the detected direction of gravity.

### BACKGROUND

Cameras can be used to capture a single image or a sequence of images to be used as frames of a video signal. Cameras may be fixed to stable objects as for example a camera may be mounted on a stand such as a tripod to thereby keep the camera still while the video frames are captured. However, often cameras may be embodied in mobile devices and are not necessarily mounted to fixed objects, for example a camera may be held in hands, or may be mounted on a moving object such as a vehicle. If the camera is not held horizontally, the pictures produced by the camera will not be horizontally aligned, which may be undesirable in some cases.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein include a camera that can output horizontally aligned pictures or videos even when the camera is held at an angle. That is, the pictures produced by the camera will be horizontally aligned even when the camera is affixed to a fixed or moving object without any regard for its orientation. In this context, all references to “picture” or “image” may also apply to the series of images that make up the frames of a video.

In one embodiment, a device is disclosed. The device includes a sensor to capture an image, a sensor to detect direction of gravity and a processor configured to extract a part of the image to produce a horizontally aligned image using the detected direction of gravity.

In another embodiment, a method for image processing is disclosed. The method includes capturing an image using a camera device. For use in video, multiple images may be horizontally aligned relative to one another, if needed, to remove or reduce effects of vibrations of the camera device during the capturing of the image. An angle of rotation of the camera device is determined using an accelerometer. A horizontally aligned image is extracted from the image based on the angle of rotation.

Alternatively, the direction of gravity is detected and transmitted to an external device with the data stream of image data.

In yet another embodiment, a computer program product is disclosed. The computer program product includes programming instructions to perform the following method for image processing. The method includes capturing an image using a camera device. For use in video, multiple images may be digitally stabilized relative to one another, if needed, to remove or reduce effects of vibrations of the camera device during capture. An angle of rotation of the camera device is determined using a sensor (e.g., an accelerometer). A horizontally aligned image is extracted from the image based on the angle of rotation.

Alternatively, this angle is attached to the image or video data as metadata. The image/video is transferred with the metadata to a computer program on an external device and a horizontally aligned image is extracted from the image based on the angle of rotation. In place of the angle of rotation the direction of gravity can be transmitted as the metadata.

Other embodiments include, without limitation, a computer-readable storage medium that includes instructions that enable a processing unit to implement one or more aspects of the disclosed methods as well as a system configured to implement one or more aspects of the disclosed methods.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only various embodiments and are therefore not to be considered limiting of the scope of the claimed subject matter.

FIG. 1 illustrates a schematic of a system for taking properly aligned pictures or videos, according to one embodiment.

FIG. 2 illustrates an example fastening device affixed to a camera, according to one embodiment.

FIG. 3 illustrates an example transformation of a picture taken by a camera held at an angle to a properly aligned picture, according to one embodiment.

FIG. 4 illustrates determining an angle of rotation, according to one embodiment.

FIG. 5 illustrates an example cropping of a picture to produce a properly aligned picture, according to one embodiment.

FIG. 6 illustrates a method of producing a properly aligned picture, according to one embodiment.

### DETAILED DESCRIPTION

In the following description, numerous specific details are set forth to provide a more thorough understanding of the described embodiments. However, it will be apparent to one of skill in the art that the described embodiments may be practiced without one or more of these specific details. In other instances, well-known features have not been described in order to avoid obscuring the described embodiments.

Reference throughout this disclosure to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some cases, it may be desirable to take pictures or shoot videos at an angle using a camera device. However, in some other cases, such as when a camera is affixed to a moving or/and at least partially rotating object, it may be desirable to produce properly aligned pictures and videos. Traditional technologies that remedy effects of vibrations or shaking a camera to produce good quality pictures still produce the pictures in which the scene is tilted at an angle if the camera was held at the angle. The embodiments described herein provide systems and methods for producing a horizontally aligned picture or video even when the camera is held at an angle at the time of the capturing of a picture.

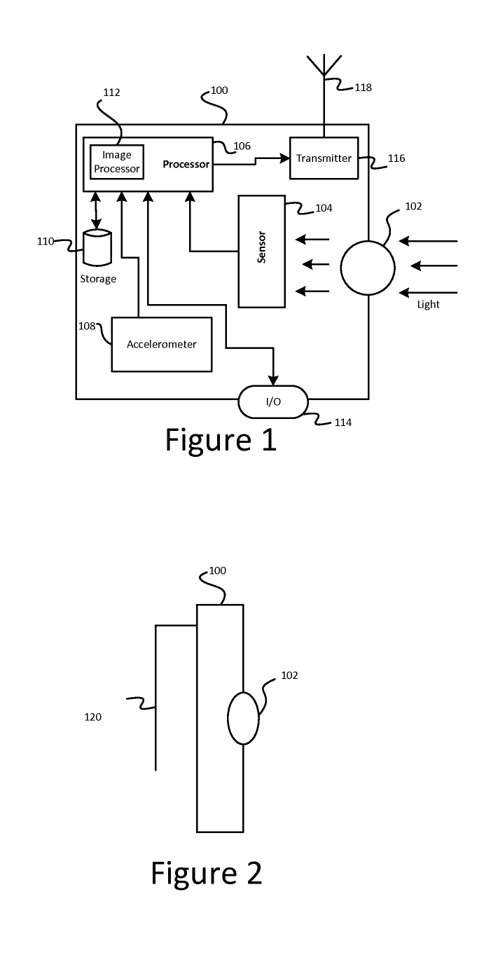

FIG. 1 illustrates a schematic of a camera device 100. The camera device 100 includes a lens 102 having a focal length that is suitable for covering a scene to be pictured. In one embodiment, a mechanical device may be included with the lens 102 to enable auto or manual focusing of the lens. In another embodiment, the camera device 100 may be a fixed focus device in which no mechanical assembly is included to move the lens 102. A sensor 104 having a sensing surface (not shown) is also included to convert an image formed by the incoming light on the sensing surface of the sensor 104 into a digital format. The sensor 104 may include a charge-coupled device (CCD) or complementary metal oxide semiconductor (CMOS) image sensor for scanning the incoming light and creating a digital picture. Other technologies or devices may be used so long as the used device is capable of converting an image formed by the incoming light on a sensing surface into the digital form. Typically, these image detection devices determine the effects of light on tiny light sensitive devices and record the changes in a digital format.

It should be appreciated that the camera device 100 may include other components such as a battery or power source and other processor components that are required for a processor to operate. However, to avoid obfuscating the teachings, these well-known components are being omitted. In one embodiment, the camera device 100 does not include a view finder or a preview display. In other embodiments, however, a preview display may be provided. The techniques described herein can be used in any type of camera, and are particularly effective in small, highly portable cameras, such as those implemented in mobile telephones and other portable user equipment. Thus, in one embodiment, the camera device 100 includes hardware or software for making and receiving phone calls.

The camera device 100 further includes an accelerometer 108. The accelerometer 108 is used for determining the direction of gravity and acceleration in any direction. A gyroscope may also be used either in addition to the accelerometer 108 or instead of the accelerometer 108. The gyroscope can provide information about how the rotational angle of the camera device 100 changes over time. Any other type of sensor may be used so long as the sensor is able to measure the direction of gravity. Using the rotational angle, an angle of rotation of the camera device 100 may be calculated, if the camera device 100 is rotated. Further included is an input/output (I/O) port 114 for connecting the camera device 100 to an external device, including a general purpose computer. The I/O port 114 may be used for enabling the external device to configure the camera device 100 or to upload/download data. In one embodiment, the I/O port 114 may also be used for streaming video or pictures from the camera device 100 to the external device. In one embodiment, the I/O port may also be used for powering the camera device 100 or charging a rechargeable battery (not shown) in the camera device 100.

The camera device 100 may also include an antenna 118 that is coupled to a transmitter/receiver (Tx/Rx) module 116. The Tx/Rx module 116 is coupled to a processor 106. The antenna 118 may be fully or partly exposed outside the body of the camera device 100. However, in another embodiment, the antenna 118 may be fully encapsulated within the body of the camera device 100. The Tx/Rx module 116 may be configured for Wi-Fi transmission/reception, Bluetooth transmission/reception or both. In another embodiment, the Tx/Rx module 116 may be configured to use a proprietary protocol for transmission/reception of the radio signals. In yet another embodiment, any radio transmission or data transmission standard may be used so long as the used standard is capable of transmitting/receiving digital data and control signals. In one embodiment, the Tx/Rx module 116 is a low power module with a transmission range of less than ten feet. In another embodiment, the Tx/Rx module 116 is a low power module with a transmission range of less than five feet. In other embodiments, the transmission range may be configurable using control signals received by the camera device 100 either via the I/O port 114 or via the antenna 118.

The camera device 100 further includes a processor 106. The processor 106 is coupled to the sensor 104 and the accelerometer 108. The processor 106 may also be coupled to storage 110 (e.g., a computer-readable storage medium), which, in one embodiment, is external to the processor 106. The storage 110 may be used for storing programming instructions for controlling and operating other components of the camera device 100. The storage 110 may also be used for storing captured media (e.g., pictures and/or videos). In another embodiment, the storage 110 may be a part of the processor 106 itself.

In one embodiment, the processor 106 may optionally include an image processor 112. The image processor 112 may be a hardware component or may also be a software module that is executed by the processor 106. It may be noted that the processor 106 and/or the image processor 112 may reside in different chips. For example, multiple chips may be used to implement the processor 106. In one example, the image processor 112 may be a Digital Signal Processor (DSP). The image processor can be configured as a processing module, that is a computer program executable by a processor. The processor 112 is used to process a raw image received from the sensor 104 based on the input received from the accelerometer 108. Other components such as Image Signal Processor (ISP) may be used for image processing. In one embodiment, the storage 110 is configured to store both raw (unmodified image) and the corresponding modified image. A processor buffer (not shown) may also be used to store the image data. The pictures can be downloaded to the external device via the I/O port 114 or via the wireless channels using the antenna 118. In one embodiment, both unmodified and modified images are downloaded to the external device when the external device sends a command to download images from the camera device 110. In one embodiment, the camera device 100 may be configured to start capturing a series of images at a selected interval

In one embodiment, a raw image from the sensor 104 is inputted to an image processor (such as an ISP) for image or color correction. In one example embodiment, the image rotation mechanism described herein is applied to the image outputted by the image processor. In other embodiments, the image rotation mechanism may be applied to the raw image received from the sensor 104. After the image rotation mechanism described herein is applied to the image outputted by the image processor, the modified image is encoded. The image encoding is typically performed to compress the image data.

In an example embodiment, the camera device 100 may not include the components for processing the image captured by the sensor 104. Instead, the camera device 100 may include programming instructions to transmit the raw image after extracting the image from the sensor 104 to a cloud based processing system that is connected to the mobile device 100 via the Internet or a local area network. The cloud based system is configured to receive the raw image and the angle of rotation of the camera device 100 (or simply the direction of gravity) and to process the raw image through an image processor. For example, the direction of gravity could be embedded as metadata in a data stream including data defining the raw image. In another embodiment, after the extraction, instead of transmitting a raw image, the camera device 100 processes the raw image through an image processor (such as an ISP) and then transmits the processed image to the cloud based image processing system. The cloud based image processing system then rotates and crops the image according to the direction of gravity and process the rotated image through an image encoder, using methods of image rotation described in this disclosure. The encoded image is then either stored in a selected cloud based storage or the image is sent back to the camera device 100 or to any other device according to a user configuration. The use of a cloud based image processing system is advantageous because it reduces a need for incorporating several image processing components in each camera device, thus making a camera device lighter, more energy efficient and cheaper.

In another example embodiment, instead of a cloud based image processing, the camera device 100 may send either a raw image or the image processed through an image processor to another device, e.g., a mobile phone or a computer. The image may be transmitted to the mobile phone (or a computer) for further processing via Wi-Fi, Bluetooth or any other type of networking protocol that is suitable for transmitting digital data from one device to another device. After the mobile device produces a horizontally aligned image, according to one or more embodiments described herein, the produced image, after the alignment, may be saved to local storage on the device, transferred for storage in a cloud based storage system, or transmitted to another device, according to user or system configurations.

In one embodiment, the native image processing system in the camera device 100 may produce images and/or videos in a non-standard format. For example, a 1200×1500 pixel image may be produced. This may be done by cropping, scaling, or using an image sensor with a non-standard resolution. Since methods for transforming images in a selected standard resolution are well-known, there will be no further discussion on this topic.

Various embodiments described above and below can be implemented utilizing a computer-readable storage medium or media that includes instructions that enable a processing unit to implement one or more aspects of the disclosed methods as well as a system configured to implement one or more aspects of the disclosed methods.

Computer-readable storage media, such as one or more memory components, can include, by way of example and not limitation, random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computer-readable storage media can also include a mass storage media device. Thus, computer readable storage media is intended to refer to statutory forms of media. As such, computer readable storage media does not describe carrier waves or signals per se.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory media.

Moving on to FIG. 2, which illustrates an optional fastening device 120 attached to the camera device 100. It may be noted that even though the camera device 100 is shown to be of square or rectangular shape, the camera device 100 can be manufactured in any shape so long as the shape and size is suitable and sufficient to accommodate the above described components of the camera device 100. The outer enclosure of the camera device 100 may be made of a metal molding, a synthetic material molding or a combination thereof. In other embodiments, any other type of material may be used so long as the material can provide a durable and strong outer shell for typical portable device use. In one embodiment, the camera device 100 may include an optional fastening device 120 attached to one side of the camera device 100 body. The fastening device 120 may be a simple slip-on clip, a crocodile clip, a hook, a Velcro or a magnet or a piece of metal to receive a magnet. The camera device 100 may be affixed permanently or semi-permanently to another object using the fastening device 120. In another embodiment, the camera device 100 does not include any fastening device. In yet another embodiment, a housing may be fabricated on a receiving object to receive the above described components of the camera device 100. In other embodiments, the camera device 100 does not include its own housing, instead the internal components (e.g., the lens 102, the sensor 104, etc.) are encapsulated in another object (e.g., a mobile phone or a tablet computer).

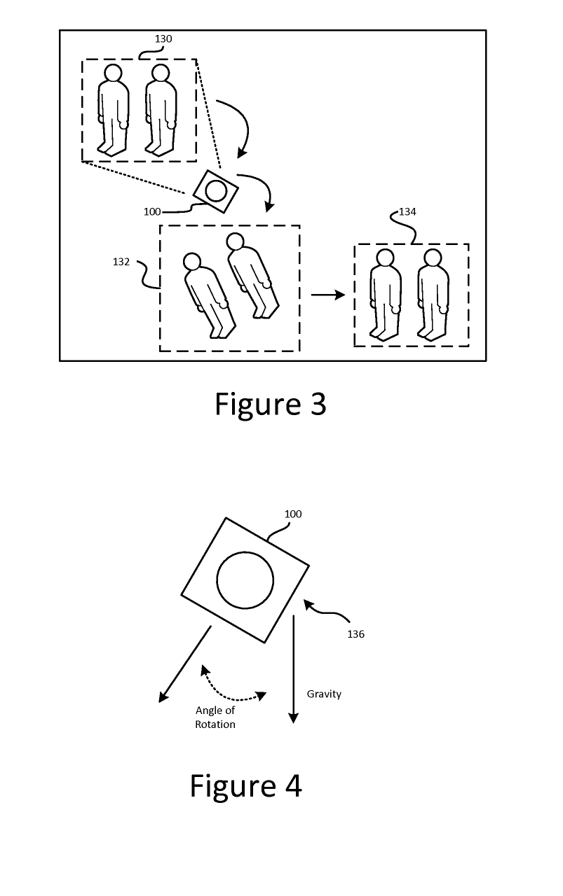

FIG. 3 illustrates a process of producing a horizontally aligned picture. Accordingly, the camera device 100 is held at an angle from the horizontal line parallel to the ground and is pointed to a scene 130. Consequently, the captured image 132, when seen with reference to the horizontally aligned plain, is tilted proportional to the angle. The processor 106 or the image processor 112 embodied in the camera device 100 obtains the direction of gravity from the accelerometer 108 to determine the angle of rotation (i.e., the tilt angle of the camera device 100). The image processor 112 then calculates a horizontally aligned rectangular area in the image 132 and crops out the pixels outside the rectangular area to produce a horizontally aligned image 134. The image can be scaled down if necessary.

FIG. 4 illustrates the operations of the accelerometer 108 that is embodied in the camera device 100 and coupled to the processor 106. The camera device 100 is calibrated in such a way that when the camera device 100 is held parallel to the ground (e.g., in the example illustration, the side 136 of the camera device 100 is parallel to the ground or horizontal plane), a hypothetical plane perpendicular to the ground coincides with the direction of gravity. When the camera device 100 is tilted, the processor 106, with the help of the accelerometer 108, determines the angle of tilt with respect to the direction of gravity. The accelerometer 108 can be an analog accelerometer, a digital accelerometer, a microelectromechanical systems (MEMS) accelerometer or a piezoelectric sensor or any other device that is capable of measuring acceleration or rotation of an object. Typically, an accelerometer senses deviation from free-fall and this information can be translated into the approximate direction of gravity. Typically, an accelerometer includes a circuit detecting changes in electrical properties caused by translational acceleration or accelerative force.

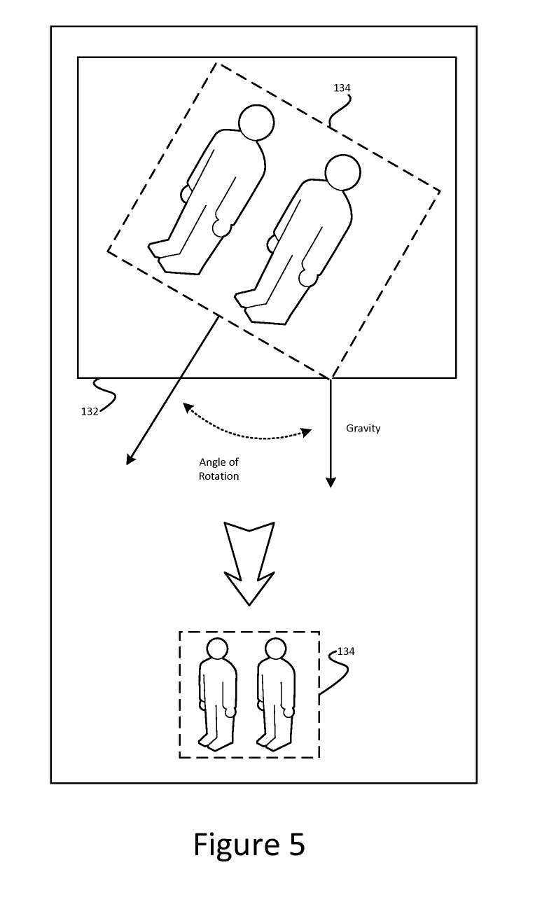

FIG. 5 further describes the process depicted in FIG. 3. When the processor 106 (or the image processor 112) receives an image 132 from the sensor 104, the processor 106 determines the angle of rotation with the help of the accelerometer 108. The processor 106 then determines a rectangular area 134 in the received image 132. In one embodiment, the rectangular area 134 is selected in such a way that the center of the selected rectangular area 134 either coincides with the center of the image 132 or as close as possible to the center of the image 132. In another embodiment, the size of the rectangular area is selected in order to allow future images to be rotated at different angles but output the same image size. The rectangular area 134 is rotated by the angle of rotation in the opposite direction. Alternatively, the processor 106 identifies a rectangular area of optimum size (e.g., the greatest possible area of the rectangular shape 134 wherein the rectangular shape 134 is either fully or substantially within the boundaries of the received image 132) in which the side lines are tilted substantially by the same angle as the angle of rotation.

In one embodiment, a crop-out process may be used to discard all pixels outside the rectangular area 134 and then rotate the rectangular image 134 back by the angle of rotation in the opposite direction of the rotation of the camera device 100. The final image 134 is stored in the storage 110. Alternatively, the storing step may be skipped and the final image 134 may be transmitted to an external device by the processor 106 via the transmitter 116. In some embodiments, the final image 134 is encoded to a selected data format, e.g., JPEG, PNG, etc. or combined with multiple images and encoded into a standard video format, e.g. H.264, MP4, etc.. The encoding may be performed by an encoder module (not shown) executable by the processor 106. The encoding may help reduce the size of the final image and also make the final image capable of being read by commonly available image/video players.

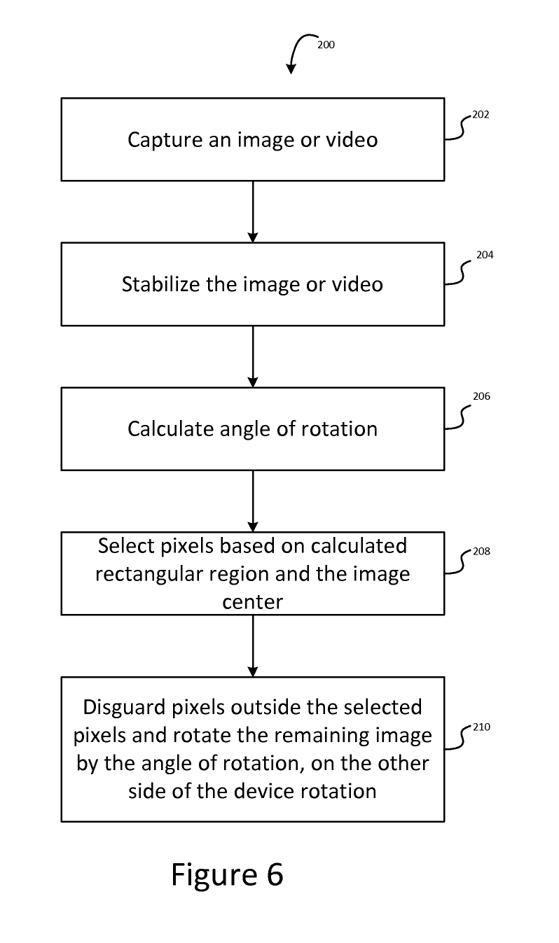

FIG. 6 illustrates an example process 200 of producing horizontally aligned images and videos. Accordingly, at step 202, the camera device 100 is used for capturing an image or video. The capturing may be initiated by sending a control signal from an external device. Alternatively, the camera device 100 may be configured to capture images automatically, for example, based on an input from a motion sensor. In another embodiment, the camera device 100 may be configured to continuously capture a series of images as soon as the camera device 100 is turned on. The camera device 100 may be held at an angle to the direction of gravity during the capturing of the image or video. The capturing is performed by the sensor 104 and the captured image is transferred to the processor 106. At step 204, the captured image or video may be stabilized to remove or reduce vibrations of the camera device 100. At step 206, the processor 106 determines the angle of rotation of the camera device 100. The angle of rotation corresponds to the tilt angle of the camera device 100 from the direction of gravity. At step 208, the image processor 112 determines a rectangular area in the captured image. The rectangular area is tilted substantially equally to the previously determined angle of rotation, in the opposite direction of the tilt of the camera device 100. The image processor 112 then selects pixels within the rectangular area. At step 210, the image processor 112 discards pixels outside the rectangular area and rotates the remaining image by the angle of rotation to make the rectangular area horizontally aligned. The selected pixels (in the rectangular area) are then either stored in the storage 110 or transmitted to an external device either via the transmitter 116 or via the I/O port 114. Optionally, the selected pixels may be encoded to form an image file in a selected data format.

Although the various embodiments have been described in language specific to structural features and/or methodological acts, it is to be understood that the embodiments defined in the appended claims are not necessarily limited to the specific features or acts described. Rather, the specific features and acts are disclosed as example forms of implementing the various claimed embodiments.

1. A device, comprising:
an image sensor to capture an image;
an orientation sensor to detect direction of gravity; and
a processor configured to rotate the image using the direction of gravity to produce a horizontally aligned image.

2. The device of claim 1, further including an encoder module for encoding the produced image in a selected data format.

3. The device of claim 1, wherein the processor is configured to crop the corners of the rotated image.

4. The device of claim 1, further including a transmitter/receiver coupled to the processor, wherein the transmitter/receiver is configured to transmit the horizontally aligned image to an external device.

5. The device of claim 1, further including an input/output port to enable an external device to configure the processor.

6. The device of claim 1, wherein the processor is further configured to horizontally align a part of the image by identifying a rectangular area around the center of the image, wherein the rectangular area is tilted substantially by a same angle of rotation from the detected direction of gravity as the device.

7. The device of claim 6, wherein the processor is further configured to discard pixels of the image that are outside the rectangular area.

8. The device of claim 7, wherein the processor is further configured to rotate the rectangular area to be horizontally aligned based on the detected direction of gravity.

9. The device of claim 1, further including a fastening mechanism to affix the device to an external object.

10. The device of claim 1, wherein the processor is configured to determine an angle of rotation from the direction of gravity, wherein the processor is configured to extract the horizontally aligned image based on the angle of rotation.

11. The device of claim 1, wherein the orientation sensor is configured to capture a series of images to output as a video, each image being rotated so as to be horizontally aligned.

12. A method, comprising:
capturing an image using a camera device;
stabilizing the image to remove or reduce effects of vibrations of the camera device during the capturing of the image;
detecting a direction of gravity using a sensor; and
transmitting to an external device a data stream of image data defining the image and the direction of gravity.

13. The method of claim 12, where the capturing is activated upon receipt of a control signal from the external device.

14. The method of claim 12, wherein the camera device is configured to start capturing a series of images at a selected interval.

15. The method of claim 12, where the camera device is configured to horizontally align a part of the image by identifying a rectangular area around the center of the image, wherein the rectangular area is tilted substantially by a same angle of rotation from the angle of rotation as the camera device.

16. A computer program product comprising program code stored in a computer readable storage medium, the program code being executable by a processor of a device to process a data stream by receiving the data stream comprising image data defining a captured image and the direction of gravity when the image was captured; and
extracting a horizontally aligned image from the image data based on the direction of gravity in the data stream.

17. The computer program product of claim 16, when embodied in a cloud based computing system the product providing the image processing components including at least one of a horizontal alignment module, an encoding module and a resolution correction module for processing the data stream.

18. The computer program product of claim 16, wherein the program code includes instructions to horizontally align a part of the image by identifying a rectangular area around the center of the image, wherein the rectangular area is tilted substantially by an opposite angle of rotation from the angle of rotation as the camera device.

19. The computer program product of claim 16, wherein the program code includes instructions to discard pixels of the image that are outside the rectangular area.

20. The computer program product of claim 16, wherein the processor is further configured to discard pixels of the image that are outside the rectangular area.

21. A mobile telephone, comprising:
a housing;
hardware within the housing for making and receiving phone calls;
an image sensor within the housing to capture an image;
an orientation sensor within the housing to detect a direction of gravity; and
a processor configured to rotate the image using the direction of gravity to produce a horizontally aligned image.

22. The mobile telephone of claim 21, further comprising an encoder module for encoding the produced image in a selected data format.

23. The mobile telephone of claim 21, wherein the processor is configured to crop the corners of the rotated image.

24. The mobile telephone of claim 21, further comprising a transmitter/receiver coupled to the processor, wherein the transmitter/receiver is configured to transmit the horizontally aligned image to an external device.

25. The mobile telephone of claim 21, further comprising an input/output port to enable an external device to configure the processor.

26. The mobile telephone of claim 21, wherein the processor is further configured to horizontally align a part of the image by identifying a rectangular area around the center of the image, wherein the rectangular area is tilted substantially by a same angle of rotation from the detected direction of gravity as the device.

27. The mobile telephone of claim 26, wherein the processor is further configured to discard pixels of the image that are outside the rectangular area.

28. The mobile telephone of claim 27, wherein the processor is further configured to rotate the rectangular area to be horizontally aligned based on the detected direction of gravity.

29. The mobile telephone of claim 21, further comprising a fastening mechanism to affix the mobile telephone to an external object.

30. The mobile telephone of claim 21, wherein the processor is configured to determine an angle of rotation from the direction of gravity, wherein the processor is configured to extract the horizontally aligned image based on the angle of rotation.

31. The mobile telephone of claim 21, wherein the orientation sensor is configured to capture a series of images to output as a video, each image being rotated so as to be horizontally aligned.

32. A method, comprising:
capturing an image using a camera device that forms part of a mobile telephone;
stabilizing the image to remove or reduce effects of vibrations of the camera device during the capturing of the image;
detecting a direction of gravity using a sensor; and
rotating the image using the direction of gravity to produce a horizontally aligned image.

33. The method of claim 32, where the capturing is activated upon receipt of a control signal from the external device.

34. The method of claim 32, wherein the camera device is configured to start capturing a series of images at a selected interval.

35. The method of claim 32, wherein the camera device is configured to horizontally align a part of the image by identifying a rectangular area around the center of the image, wherein the rectangular area is tilted substantially by a same angle of rotation from the angle of rotation as the camera device.

36. A method, comprising:
capturing an image using a camera device that forms part of a mobile telephone;
detecting a direction of gravity using a sensor; and
rotating the image using the direction of gravity to produce a horizontally aligned image.

37. The method of claim 36, where the capturing is activated upon receipt of a control signal from the external device.

38. The method of claim 36, wherein the camera device is configured to start capturing a series of images at a selected interval.

39. The method of claim 36, wherein the camera device is configured to horizontally align a part of the image by identifying a rectangular area around the center of the image, wherein the rectangular area is tilted substantially by a same angle of rotation from the angle of rotation as the camera device.
